(19) United States
(12) Patent Application Publication
(10) Pub. No.: US 2018/0173362 A1
(43) Pub. Date: Jun. 21, 2018

(54) DISPLAY DEVICE, DISPLAY METHOD USED IN THE SAME, AND NON-TRANSITORY COMPUTER READABLE RECORDING MEDIUM

(71) Applicant: SHARP KABUSHIKI KAISHA, Osaka (JP)

(72) Inventor: NORIYOSHI KANKI, Sakai City (JP)

(21) Appl. No.: 15/847,721

(22) Filed: Dec. 19, 2017

(30) Foreign Application Priority Data
Dec. 20, 2016 (JP) 2016-246990

(51) Int. Cl. G06F 3/041

(52) U.S. Cl. CPC G06F 3/0416; G06F 2203/04104

(57) ABSTRACT

A display device includes a sheet display unit that displays a sheet on which an object is to be arranged, a movement operation reception unit that receives an operation for moving the sheet, an expansion button display unit that, if an outside area is displayed as a result of the operation for moving the sheet, displays an expansion button, and a sheet expansion unit that, if the expansion button is selected, increases sheet size of the sheet in a direction of the selected expansion button.

### BACKGROUND

### 1. Field

The present disclosure relates to a display device, a display method used in the display device, and a non-transitory computer readable recording medium.

### 2. Description of the Related Art

Display devices capable of displaying various objects using an input unit such as a touch panel are known. Such a display device is used as a whiteboard, for example, and objects are drawn and arranged on a drawing sheet.

When the blank space of a sheet runs out, a user might desire to expand the sheet. In Japanese Unexamined Patent Application Publication No. 2015-203989, for example, a technique for displaying a new handwriting input area outside one of a plurality of display areas in accordance with a handwriting input operation that has begun in the display area has been disclosed.

In Japanese Unexamined Patent Application Publication No. 2010-134897, a technique for scrolling through drawing information on a drawing screen by changing a drawing target area on the drawing screen in accordance with calculated parameters and drawing the drawing information again on the drawing screen in accordance with the new drawing target area has been disclosed.

In Japanese Unexamined Patent Application Publication No. 2013-178701, a technique for improving a drawing operation in the periphery of a display, such as around a task bar, has been disclosed.

### SUMMARY

As described above, the examples of the related art only simulatively make the user think that he/she has expanded a sheet. That is, a large sheet is virtually prepared in advance, and a part of the sheet is displayed to the user.

In this case, a virtual sheet is just scrolled, and a sheet is not actually expanded.

In addition, when the user desires to actually expand a sheet in the examples of the related art, the user needs to call an expansion menu from a list of menus or the like. It therefore takes time to expand a sheet, and operability is low.

The present disclosure provides a display device and the like capable of expanding a sheet on which an object can be arranged through a simple operation.

A display device in the present disclosure includes a sheet display unit that displays a sheet on which an object is to be arranged, a movement operation reception unit that receives an operation for moving the sheet, an expansion button display unit that, if an outside area is displayed as a result of the operation for moving the sheet, displays an expansion button, and a sheet expansion unit that, if the expansion button is selected, increases sheet size of the sheet in a direction of the selected expansion button.

A display method used in a display device in the present disclosure includes displaying a sheet in which an object is to be arranged, receiving an operation for moving the sheet, displaying, if an outside area is displayed as a result of the operation for moving the sheet, an expansion button, and increasing, if the expansion button is selected, sheet size of the sheet in a direction of the selected expansion button.

A non-transitory computer readable recording medium in the present disclosure stores a program for causing a computer to perform operations including displaying a sheet in which an object is to be arranged, receiving an operation for moving the sheet, displaying, if an outside area is displayed as a result of the operation for moving the sheet, an expansion button, and increasing, if the expansion button is selected, sheet size of the sheet in a direction of the selected expansion button.

### BRIEF DESCRIPTION OF THE DRAWINGS

FIG. 1 is a diagram illustrating the appearance of a display device in the present disclosure;

FIG. 2 is a diagram illustrating a functional configuration according to a first embodiment;

FIGS. 3A and 3B are diagrams illustrating an example of a data configuration according to the first embodiment;

FIG. 4 is an operation flowchart illustrating a main process according to the first embodiment;

FIG. 5 is an operation flowchart illustrating a process for expanding a sheet according to the first embodiment;

FIGS. 6A and 6B are diagrams illustrating an outline of an operation for expanding a sheet according to the first embodiment;

FIG. 7 is an operation flowchart illustrating a process for updating a displayed sheet according to the first embodiment;

FIGS. 8A to 8C are diagrams illustrating an example of an operation according to the first embodiment;

FIGS. 9A to 9C are diagrams illustrating another example of the operation according to the first embodiment;

FIGS. 10A and 10B are diagrams illustrating an example of an operation according to a second embodiment;

FIGS. 11A to 11C are diagrams illustrating an example of an operation according to a third embodiment;

FIG. 12 is a diagram illustrating an example of an operation according to a fourth embodiment;

FIG. 13 is a diagram illustrating an example of an operation according to a fifth embodiment;

FIG. 14 is an operation flowchart illustrating a main process according to a sixth embodiment;

FIGS. 15A to 15C are diagrams illustrating an example of an operation according to the sixth embodiment;

FIG. 16 is an operation flowchart illustrating a process for updating a displayed sheet according to a seventh embodiment;

FIGS. 17A and 17B are diagrams illustrating an example of an operation according to the seventh embodiment;

FIGS. 18A to 18C are diagrams illustrating an example of an operation according to an eighth embodiment;

FIGS. 19A to 190 are diagrams illustrating another example of the operation according to the eighth embodiment;

FIG. 20 is an operation flowchart illustrating an example of an operation according to a ninth embodiment;

FIG. 21 is an operation flowchart illustrating a main process according to a tenth embodiment;

FIGS. 22A to 22C are diagrams illustrating an example of an operation according to the tenth embodiment; and

FIG. 23 is a diagram illustrating the appearance of display devices according to an eleventh embodiment.

### DESCRIPTION OF THE EMBODIMENTS

Embodiments of the present disclosure will be described hereinafter with reference to the drawings. Although the embodiments will be described while taking as an example a case in which a display device in the present disclosure is a terminal device including a touch panel for convenience of description, the display device may be any type of device insofar as a user can draw and arrange objects using the display device.

### 1. First Embodiment

### 1.1 Overall Configuration

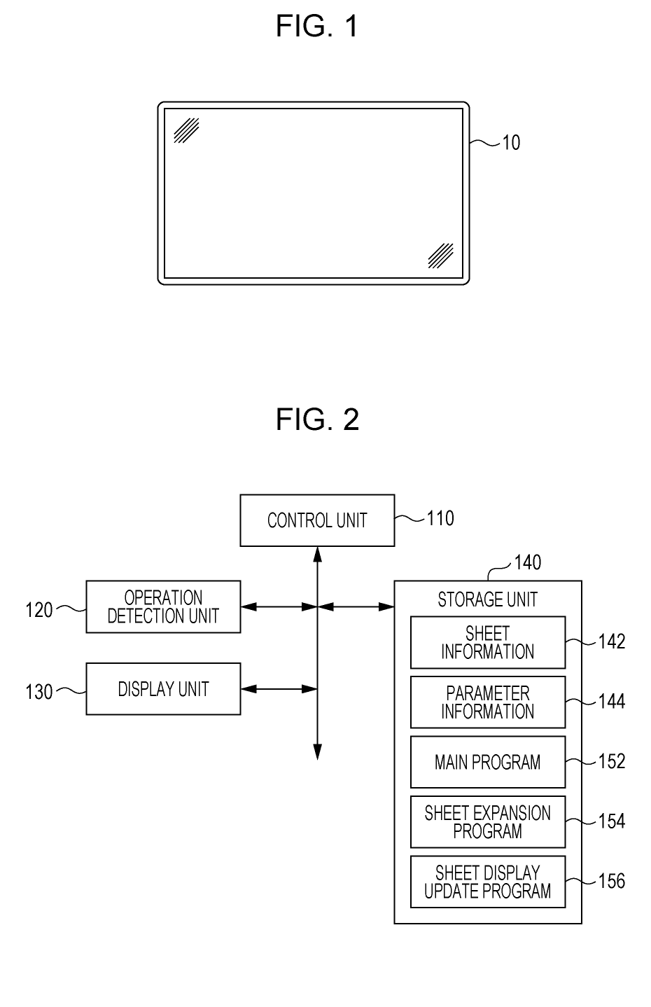

FIG. 1 illustrates the appearance of a display device 10, which is a display device in the present disclosure. The display device 10 is a liquid crystal display (LCD), for example, and includes a touch panel with which a user can perform touch input.

The touch panel receives operations performed by the user, such as a touch, a flick, and a slide. The touch panel may employ an electrostatic capacitance method or a pressure sensing method. That is, the display device may be any type of device capable of receiving operations performed by the user, such as a touch.

The display device 10 is not limited to a common touch panel display, but may be a device such as a computer, a tablet, terminal, a smartphone, or an automotive navigation system.

### 1.2 Functional Configuration

FIG. 2 illustrates the functional configuration of the display device 10 according to a first embodiment. As illustrated in FIG. 2, the display device 10 includes a control unit 110, an operation detection unit 120, a display unit 130, and a storage unit 140.

The control unit 110 is a functional component for controlling the entirety of the d splay device 10. The control unit 110 is a central processing unit (CPU), for example, and achieves various functions by reading various programs stored in the storage unit 140.

When configured as a touch panel, the control unit 110 also displays objects drawn and input through a display screen (operation detection unit 120), such as images, and controls how images input from other image input devices are displayed.

The operation detection unit 120 is a functional component for detecting operations performed by the user. The operation detection unit 120 is, for example, a touch panel integrated with the display unit 130. The operation detection unit 120 may employ any method for detecting operations, such as an electrostatic capacitance method, a pressure sensing method such as a resistive film method, an infrared method, or an electromagnetic induction method.

The display unit 130 is a functional component for displaying, to a user, various pieces of information and sheets on which objects are drawn or arranged. The display unit 130 is, for example, an LCD or an organic electroluminescent (EL) display.

The storage unit 140 is a functional component storing various programs and various pieces of data used to operate the display device 10. The storage unit 140 is, for example, a semiconductor memory such as a solid-state drive (SSD) or a magnetic disk such as a hard disk drive (HDD).

The storage unit 140 stores sheet information 142, parameter information. 144, a main program 152, a sheet expansion program 154, and a sheet display update program

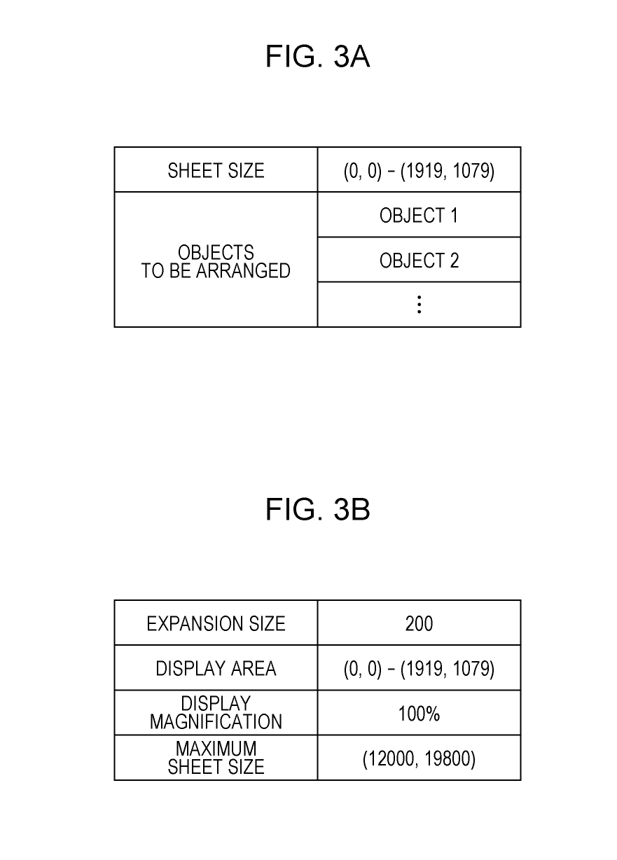

The sheet information 142 is information regarding sheets. As illustrated in FIG. 3A, the sheet information 142 is information regarding a sheet size (e.g., “(0, 0)-(1919, 1079)”) and objects to be arranged.

A sheet herein refers to image data, a layer, or a canvas on which various objects can be arranged or drawn. When the user draws a handwritten object, the handwritten object is provided on a sheet.

The sheet size usually matches the size of a display area based on the display unit 130. The user can use the sheet like an electronic blackboard to arrange or draw objects.

There may be a plurality of sheets. In this case, the user can display another sheet by performing a certain operation (e.g., a swipe).

As described above, the sheet size often matches the size of the display area, but may be different from the size of the display area. In this case, an object larger than the sheet size can be arranged or drawn, and even when the display area is not large enough to d splay the entirety of an object, the user can arrange or draw the object in an additional area.

The sheet size refers to the size of a sheet, and the sheet information 142 includes information regarding the size of a sheet. In FIG. 3A, length and width are stored as an example of the sheet size. Alternatively, coordinates (relative coordinates or absolute coordinates) may be stored, or the number of pixels may be stored. If a sheet is a file, attributes of the file may be referred to.

In the field of “objects to be arranged”, objects to be arranged on a sheet are stored. Objects can be objects drawn by the user or objects obtained by pasting. another file. As the content of an object, coordinates at which the object is to be drawn, the size of the object, stroke data, text data, file data such as an image or a sound, document data, and the like are stored. Any known method may be used as a method for drawing an object on a sheet on the basis of information regarding the object.

An expression “expand a sheet” used herein means that the sheet size increases. More specifically, an expression “a sheet expands downward” used herein means that the sheet size increases downward.

The parameter information 144 includes parameters and attributes relating to sheets, parameters used when a program has been executed, and the like. As illustrated in FIG. 3B, for example, the parameter information 144 includes an expansion size (e.g., “200”), a display area (e.g., (0, 0)-(1919, 1079)), a display magnification (e.g., “100%”), and a maximum sheet size (e.g., “(12000, 19800)”).

The expansion size refers to a size by which a sheet size is increased in a process that will be described later. The expansion size may be defined by length and width or in upward, downward, leftward, and rightward directions. Although the expansion size is defined by the number of pixels in the present embodiment, the expansion size may be defined by percentage or any other variable set by the user, instead.

The display area refers to a part or the entirety of a sheet currently displayed on the display device 10. In the present embodiment, the display area is indicated by coordinates, which may be relative coordinates or absolute coordinates.

The display magnification refers to a magnification of a sheet relative to the display area. The display magnification is a magnification by which a sheet and objects arranged on the sheet are displayed and can be arbitrarily set by the user.

The maximum sheet size refers to a maximum size to which a sheet can be expanded. In the present embodiment, an operation for expanding a sheet is not accepted if the operation makes the sheet size larger than the maximum sheet size. As the maximum sheet size, a length and a width may be stored as illustrated in FIG. 3B, or a length or a width may be stored, instead. Depending on the system, the maximum sheet size need not be set.

The control unit 110 reads and executes the main program 152, the sheet expansion program 154, and the sheet display update program 156 to achieve functions corresponding to the programs. Processes based on these programs will be described later.

Although the display device 10 solely performs display, drawing, and control in the present embodiment, another device may perform such operations, instead. For example, a drawing device (e.g., a computer) connected, through universal serial bus (USB) or High-Definition Multimedia Interface (HDMI; registered trademark), to a display device capable of detecting a touch may perform operations.

### 1.3 Processing Flows

Next, processing flows according to the present embodiment will be described.

### 1.3.1 Main Process

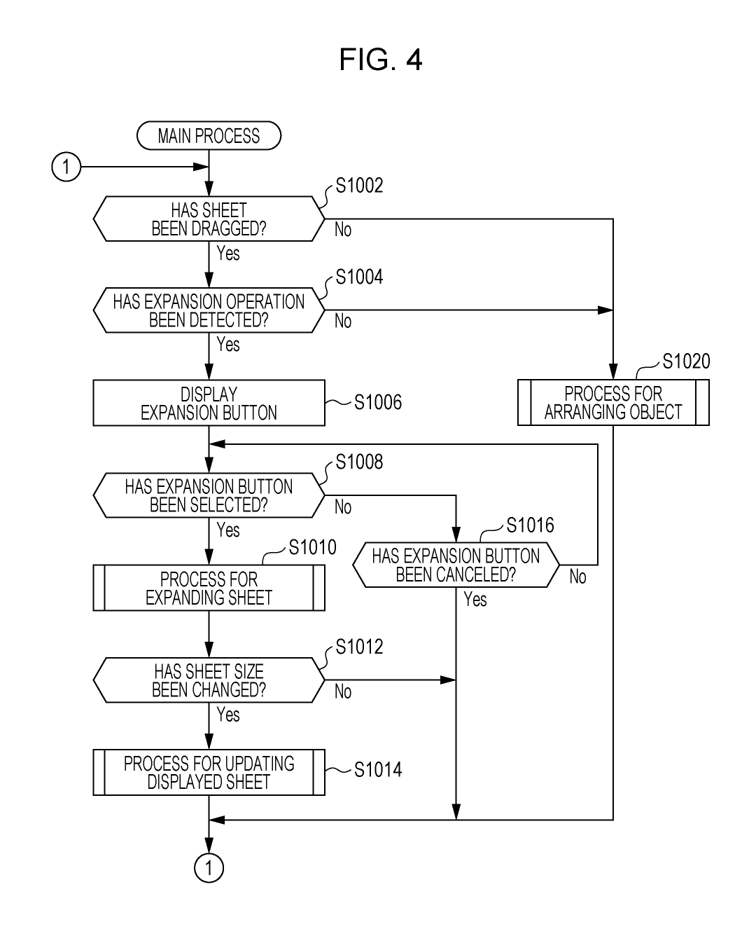

A main process will be described with reference to FIG. 4. The main process is achieved when the control unit 110 reads and executes the main program 152 stored in the storage unit 140.

First, as an operation performed on a sheet, whether a drag operation has been detected is determined (step S1002). The operation performed on a sheet may be one of various operations. For example, as operation for moving a sheet (an operation for moving a part of a sheet displayed in the display area) or an operation for switching a sheet (e.g., an operation for switching between a plurality of sheets) is detected. In the present embodiment, the operation for switching a sheet is performed as a flick operation, and the operation for moving a sheet is performed as a drag operation. A type of operation may change depending on whether an operation has been performed with one finger or two fingers.

In addition, an operation can be performed on an object by touching the object displayed on a sheet, and a new object can be arranged or drawn by selecting a mode (e.g., a handwriting pen, etc.) and dragging a sheet.

As described above, by dragging the sheet with two fingers, for example, an operation for dragging the sheet is detected (YES in step S1002).

After the sheet is dragged, whether an expansion operation has been detected is determined (step S1004). In the present embodiment, an expansion operation is detected if a sheet end (a side of the sheet) has been moved into the display area and an area outside the sheet (hereinafter referred to as an “outside area”) in which an object cannot be arranged has been displayed. That is, the sheet end is displayed, and the sheet and the outside area (e.g., a gray area) are displayed in the display area.

If an expansion operation is detected (YES in step S1004), that is, if a sheet end is displayed and the outside area is also di played, an expansion button is displayed in the outside area (step S1006).

The expansion button is displayed at a position a certain distance away from the sheet end. When a rightward expansion button is displayed, for example, the rightward button is displayed 24 pixels (pels) away from a right end of the sheet at a vertically central position of the sheet displayed on the screen. Here, a certain value is set in advance for the position at which an expansion button is to be displayed, but the user may set a value, instead. The user may also set the size, the shape, or the color of an expansion button or the like.

Whether the user has selected the expansion button is determined (step S1008). If the user has not selected the expansion button, the process stands by until the expansion button is selected or canceled (NO in step S1008→NO in step S1016→step S1008). If the expansion button. is canceled (e.g., another operation is performed), the process is performed again from step S1002 (NO in step S1008→YES in step S1016→step S1002).

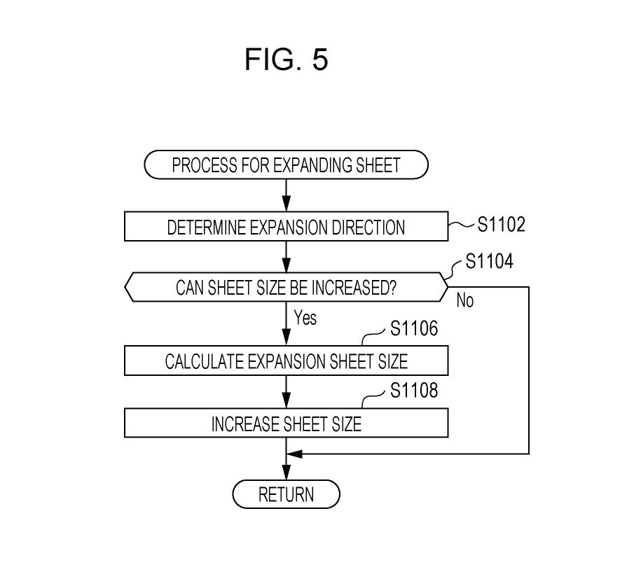

If the expansion button is selected (YES in star S1008), a process for expanding a sheet is performed in accordance with the position at which the sheet expansion button has been selected (step S1010). The process for expanding a sheet will be described later with reference to FIG. 5.

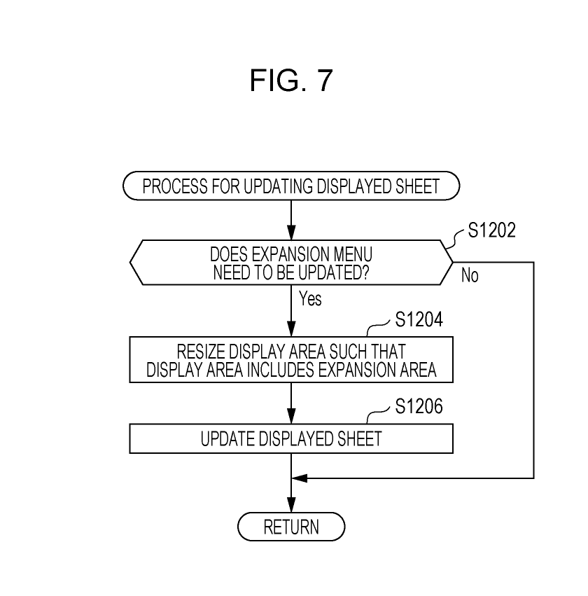

If the sheet size has been increased as a result of the process for expanding a sheet, the change to the sheet is detected, and a process for updating a displayed sheet is performed (YES in step S1012→step S1014). The process for updating a displayed sheet will be described later with reference to FIG. 7.

If a drag operation is not performed on the sheet (NO in step S1002), or if a drag operation is performed on the sheet but an expansion operation is not detected, a process for arranging an object is performed (step S1020).

The process for arranging an object is a process performed by the user to arrange and display an object on a sheet. For example, a handwritten object is arranged by drawing the object, a text object is arranged by inputting text, or a content file such as a still image or a moving image with sound is arranged by pasting the content file.

The term “arrangement” in the present embodiment refers to display or drawing of an object, display of text data, display of image data, or drawing of stroke data based. on handwritten data or the like. In addition, when a sound or a moving image is arranged as content, the sound is played back (output).

In addition, an arranged object can be subjected to various operations, such as movement, modification, resizing, and removal. The process for arranging an object is achieved by a conventional whiteboard function or the like, and detailed description thereof is omitted.

Although the process for arranging an object has been described for convenience of description, a movement: process based on a drag operation may be performed on a sheet, or a process for switching a sheet may be performed by detecting a swipe operation, instead.

### 1.3.2 Process for Expanding Sheet

The process for expanding a sheet will be described with reference to FIG. 5. The process for expanding a sheet is achieved when the control unit 110 reads and executes the sheet expansion program 154 stored in the storage unit 140.

First, an expansion direction of the sheet size is determined (step S1102). In the present embodiment, one of displayed expansion buttons is selected to expand a sheet in a desired direction. That is, a direction corresponding to a selected expansion button is determined.

Next, whether the sheet size can be increased is determined (step S1104). In this determination, for example, whether a sheet size with which processing can be performed will be exceeded or whether the maximum sheet size set by the user will be exceeded is determined.

In the present embodiment, whether the sheet size will exceed the maximum sheet size is determined. The maximum sheet size is included in the parameter information 144. If the sheet size will exceed the maximum sheet size, it is determined that the sheet is not to be expanded.

If the sheet size can be increased (YES in step S1104), an expansion sheet size is calculated (step S1106). For example, an expansion size is read from the parameter information 144, an area to be added to the sheet in the direction determined in step S1102 is calculated, and the sheet size is increased (step S1108).

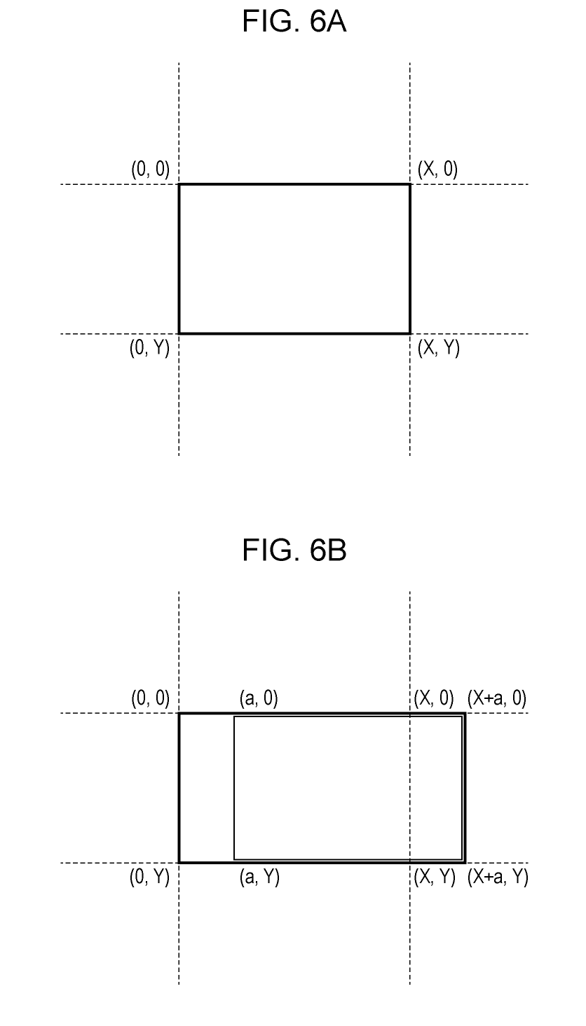

An operation for increasing the sheet size will be described with reference to FIGS. 6A and 6B. FIG. 6A is a diagram illustrating a basic state. For example, a sheet is defined by coordinates (0, 0)-(X, Y). The coordinates may be relative coordinates or absolute coordinates. The sheet is indicated by a solid line. In this case, the size of the display area and the size of the sheet match. If an operation for expanding a sheet rightward is performed, the sheet size increases as illustrated in FIG. 6B. That is, the sheet expands rightward by a defined expansion size. If the expansion size is included in the parameter information 144 as “a”, for example, the sheet size increases to (0, 0)-(X+a, Y).

In FIG. 6B, the display area is indicated by a thin line. That is, the display area is (a, 0)-(X+a, Y). Various methods, which will be described later, may be used to specify a part or the entirety of a sheet to be displayed in the display area.

As a method for increasing the sheet size, a method in which the sheet size is redefined by expanding the sheet rightward as coordinates, a method in which an expansion is determined as an expansion area and the sheet size is increased by adding the expansion area to a current sheet, or the like may be used.

When the sheet size increases upward, for example, the sheet size increases from (0, 0)-(X, Y) to (0, 0-a)-(X, Y).

Although a sheet is expanded by the expansion size included in the parameter information 144 in the present embodiment, the expansion size may be calculated, instead. If a sheet is vertically expanded, for example, the sheet may be expanded by “the length of a default sheet size/4× the width of the sheet size”, and if a sheet is horizontally expanded, the sheet may be expanded by “the width of the default sheet size/4× the length of the sheet size”. That is, if an expansion direction is selected in this case, a sheet is expanded by a quarter of the default sheet size. A sheet may be expanded by another ratio, namely, for example, one-fifth or one-third, instead.

If the sheet size is already at its maximum when a sheet is to be expanded, the sheet need not be expanded.

In the present embodiment, an expansion button is displayed on the basis of a drag operation performed on a sheet, and the user can thus easily and intuitively increase the sheet size. Since a minimum required sheet size is used, the amount of data used in a memory is small. The sheet size can be increased with a small load even in the case of a device whose processing speed is low and memory is small, such as a smartphone or a tablet.

### 1.3.3 Process for Updating Displayed Sheet

The process for updating a displayed sheet will be described with reference to FIG. 7. The process for updating a displayed sheet is achieved when the control unit 110 reads and executes the sheet display update program 156 stored in the storage unit 140.

Whether a displayed sheet needs to be updated is determined (step S1202). In this determination, for example, whether the expanded sheet is included in the display area is determined. Alternatively, the user may make settings relating to update of a displayed sheet, and whether to update the displayed sheet may be determined on the basis of the settings.

If the displayed sheet is to be updated, an operation in step S1204 is performed. More specifically, the display area is resized such that the display area includes the entirety of an expansion (step S1204). Since the display area has been resized, the displayed sheet is updated (step 31206).

### 1.4. Example of Operation

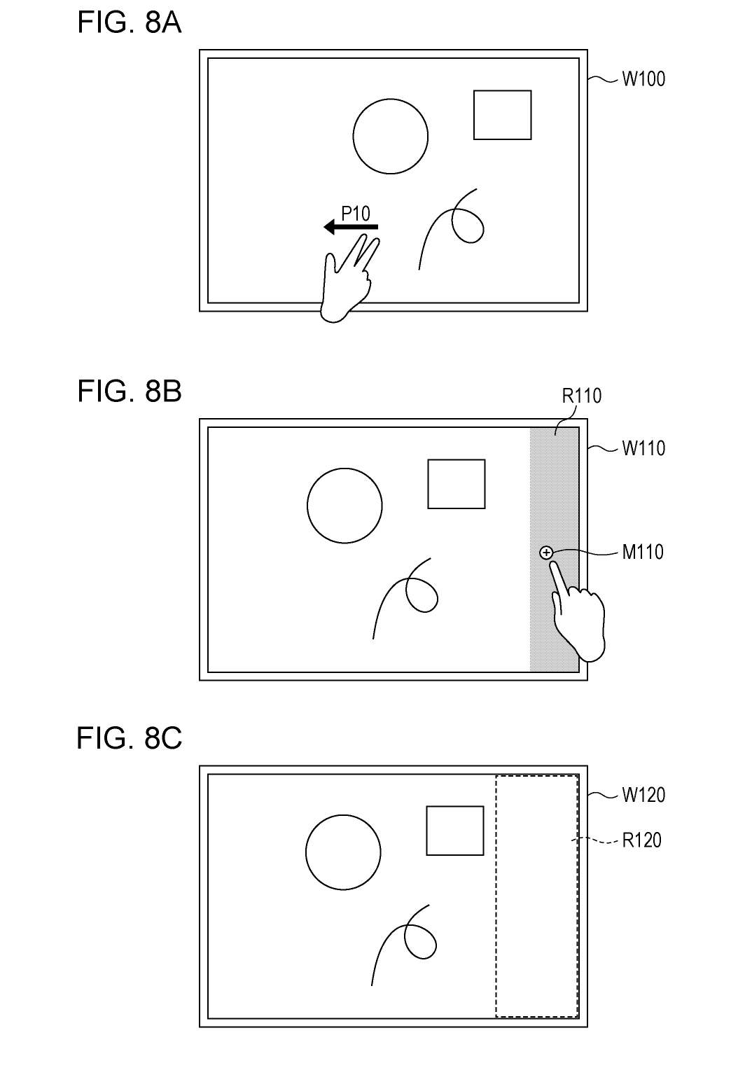

An example of an operation according to the present embodiment will be described with reference to FIGS. 8A to 8C. FIG. 8A illustrates an example of a display screen W100 on which a sheet included in a display area is displayed. A plurality of objects are arranged on the sheet.

Here, the user performs a drag operation on the sheet. For example, the user performs a rightward (direction P10) drag operation with two fingers to drag the displayed sheet.

FIG. 8B illustrates an example of a display screen W110 at a time when the user has kept &ragging the displayed sheet rightward. As illustrated in FIG. 8B, by keeping dragging the sheet, an outside area R110 is displayed. By dragging the sheet, the sheet moves and a sheet end enters the display area (the entirety of the sheet has already been displayed in the display area). The outside area R110 is thus displayed.

Various methods may be used to determine the size of the outside area R110. For example, the outside area R110 may be displayed in accordance with a drag operation, or the outside area R110 of a certain size may be displayed when a sheet end has been displayed.

Here, an expansion button M110 is displayed in the outside area R110. The expansion button M110 remains displayed while the outside area R110 is display The expansion button M110 is displayed a certain nets (e.g., 20 pels) away from a right end of the sheet around a vertically central position of the sheet. The expansion button M110 may follow a subsequent drag operation or stay at the same position. Alternatively, the expansion button M110 may follow a subsequent drag operation horizontally but may stay around the vertically central position of the sheet. The above displayed position is an example, and the expansion button M110 may be displayed at a position one-third of the length of a sheet away from an upper end of the sheet, or a plurality of expansion buttons may be displayed at a position one-third of the length of a sheet away from an upper end of the sheet and a position one-third of the length of the sheet away from a lower end of the sheet, respectively, instead.

When the sheet end moves out of the display screen again (i.e., the display area includes only the sheet) as a result of a drag operation performed on the sheet, the expansion button M110 is removed. That is, it is determined that the process performed on the expansion button M110 has been canceled.

Here, the expansion button M110 may be displayed or removed in accordance with display or removal of the outside area R110 or in accordance with whether a position of the expansion button M110.

FIG. 8C illustrates an example of a display screen W120 at a time when the user has selected the expansion button M110. If the user selects the expansion button M110, the sheet size increases rightward by a certain size. In FIG. 8C, the sheet size has increased by the size of a sheet expansion area R120. When the sheet size increases, the entirety of the sheet is moved and displayed.

As the sheet expansion area R120, as described above, the expansion size included in the parameter information 144 may be used, or an expansion size may be calculated from the size of a new sheet and then a sheet may be expanded.

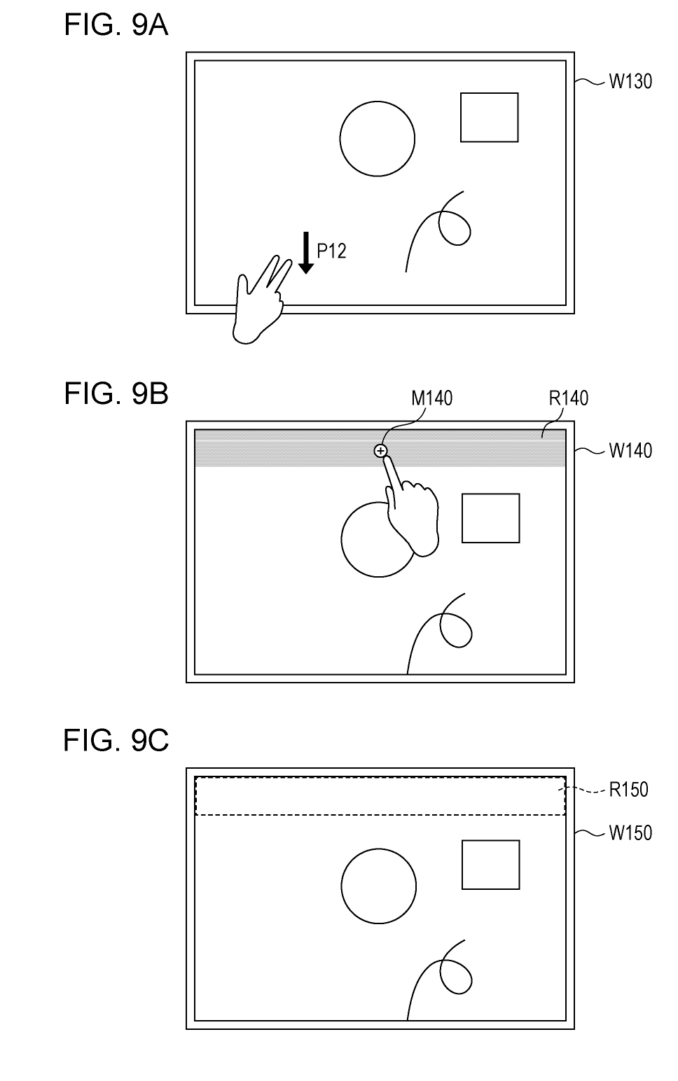

Although an example in which a sheet is expanded rightward has been described with reference to FIGS. 8A to 8C, a sheet may be expanded in another direction, instead. For example, FIGS. 9A to 9C are diagrams illustrating a case in which a sheet is expanded upward.

On a display screen W130 illustrated in FIG. 9A, the user performs a downward (direction P12) drag operation with two fingers. A display screen W140 illustrated in FIG. 9B is displayed as a result of the drag operation. By keeping dragging the sheet, an upper end of the sheet is displayed. If the user further keeps dragging the sheet, an outside area R140 is displayed. An expansion button M140 is displayed in the outside area R140.

FIG. 9C illustrates an example of a display screen W150 displayed when the user has touched the expansion button M140. In FIG. 9C, the sheet size has increased by the size of a sheet expansion area R150.

According to the present embodiment, the user can easily expand a sheet by selecting an expansion button displayed in an outside area.

### 2. Second Embodiment

A second embodiment will be described. In the present, embodiment, an expansion button is not displayed in an outside area but on a sheet. A functional configuration and processing flows according to the present embodiment are basically the same as those according to the first embodiment, and differences from the first embodiment will be mainly described.

More specifically, a position at which an expansion button is displayed in step S1006 in the main process illustrated in FIG. 4 is different from that in the first embodiment. In the first embodiment, an expansion button is displayed at a certain position outside a sheet, that is, beyond a sheet end. In the present embodiment, on the other hand, an expansion button is displayed within a sheet end. An expansion button for expanding a sheet rightward, for example, is displayed 24 pels (−24 pels from a right end of the sheet) within the sheet end (inside the sheet) around a vertically central position of the sheet.

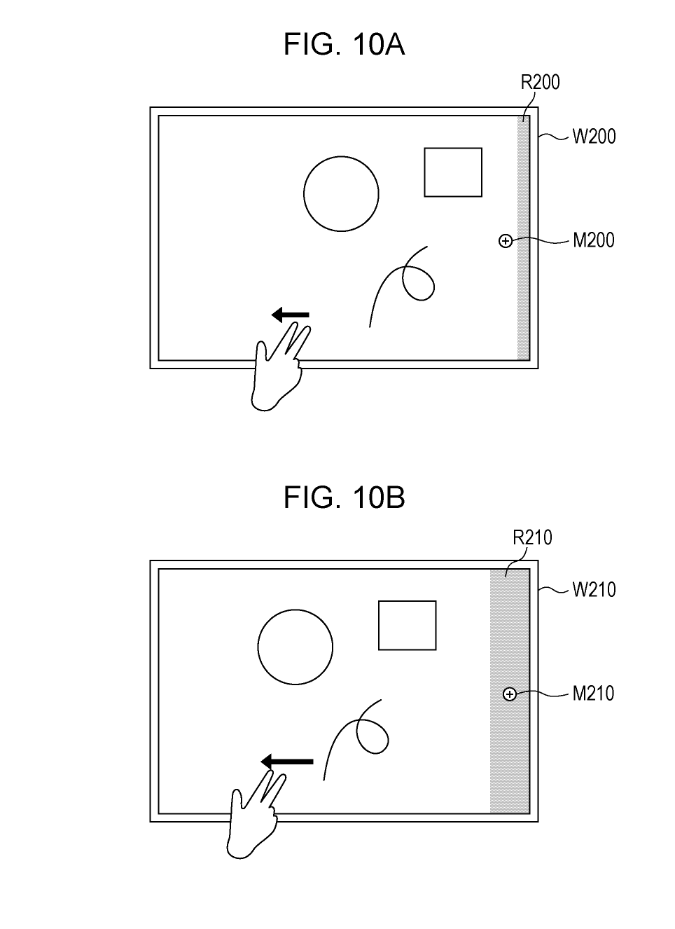

In this case, for example, the expansion button may remain di played on the sheet during the drag operation. If an outside area of a certain size is created, the expansion button may then be displayed in the outside area. If the outside area R210 has become large enough to display an expansion button M210 as indicated by a display screen W210 illustrated in FIG. 10B, the expansion button M210 may be displayed.

According to the present embodiment, an expansion button can be displayed on a sheet or displayed on a sheet or in an outside area depending on a situation. The expansion button, therefore, can be displayed immediately after a sheet end is displayed, that is, the expansion button can be displayed and selected with a smaller amount of movement.

Although the first and second embodiments have been individually described herein, the first and second embodiments may be combined with each other insofar as no contradiction is caused.

### 3. Third Embodiment

A third embodiment will be described. In the present embodiment, the user can select a size by which a sheet is to be expanded. A functional configuration and processing flows according to the present embodiment are the same as those according to the first embodiment, and differences from the first embodiment will be mainly described.

In the present embodiment, in the process for calculating an expansion sheet size performed in step S1106 in the process for expanding a sheet illustrated in FIG. 5, the size of the outside area is used as the size of a sheet expansion area.

For example, the user performs a drag operation to move a sheet. A sheet end is displayed, and then an outside area is displayed. If an expansion button is selected, the sheet is expanded in a direction of the expansion button.

At this time, the size of the outside area (the size of an area outside a right end in the case of rightward expansion) is set as an expansion size. As a result, the user can arbitrarily set a desired sheet expansion size.

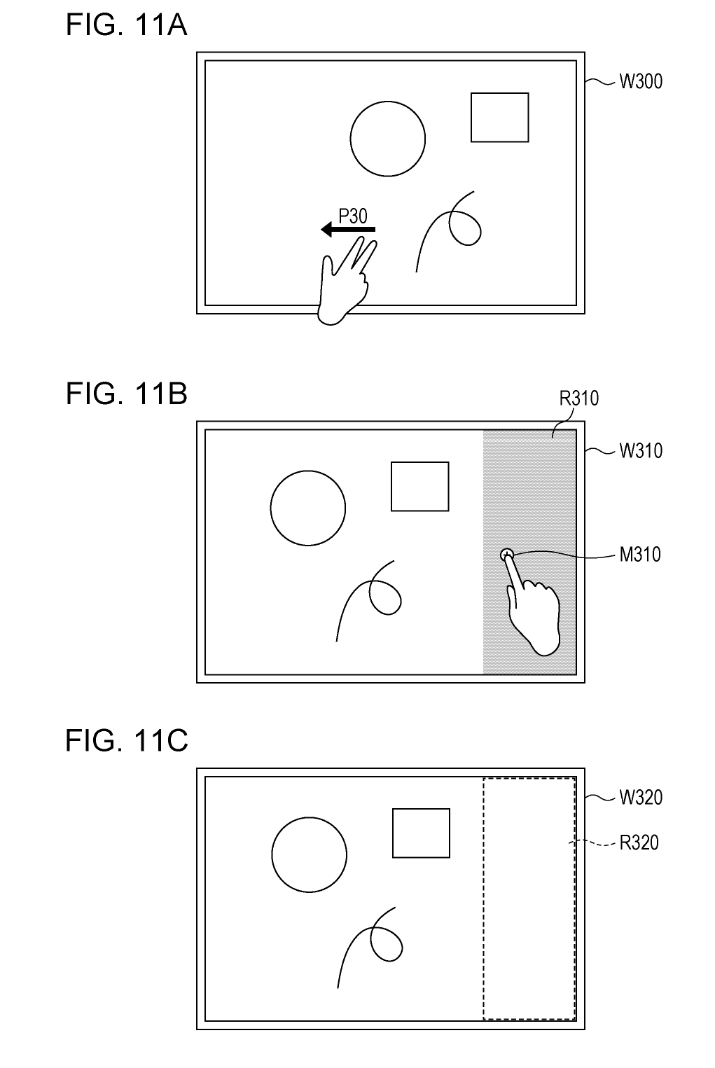

An operation according to the present embodiment will be described with reference to FIGS. 11A to 11C. FIG. 11A is a diagram illustrating an example of a display screen W300 according to the present embodiment. If the user drags a sheet in a direction P30 with two fingers, a right end is included in the d splay area, and the sheet is moved leftward. As indicated by a display screen W310 illustrated in FIG. 11B, an outside area R310 is displayed. An expansion button M310 is displayed in the outside area R310.

If the user selects the expansion button M310, the sheet is expanded by the width of the outside area R310 as a sheet expansion area W320 as indicated by a display area W320 illustrated in FIG. 11C.

According to the present embodiment, the user can expand a sheet in accordance with the size of a displayed outside area.

### 4. Fourth Embodiment

A fourth embodiment will be described. In the present embodiment, an upper limit is provided for a drag operation. A functional configuration and processing flows according to the present embodiment are the same as those according to the first embodiment, and differences from the first embodiment will be mainly described.

In the fourth embodiment, a threshold of a drag operation is provided in the operation for dragging and expanding a sheet in steps S1002 and S1004 in the main process illustrated in FIG. 4. If the threshold is exceeded, a sheet is no longer moved.

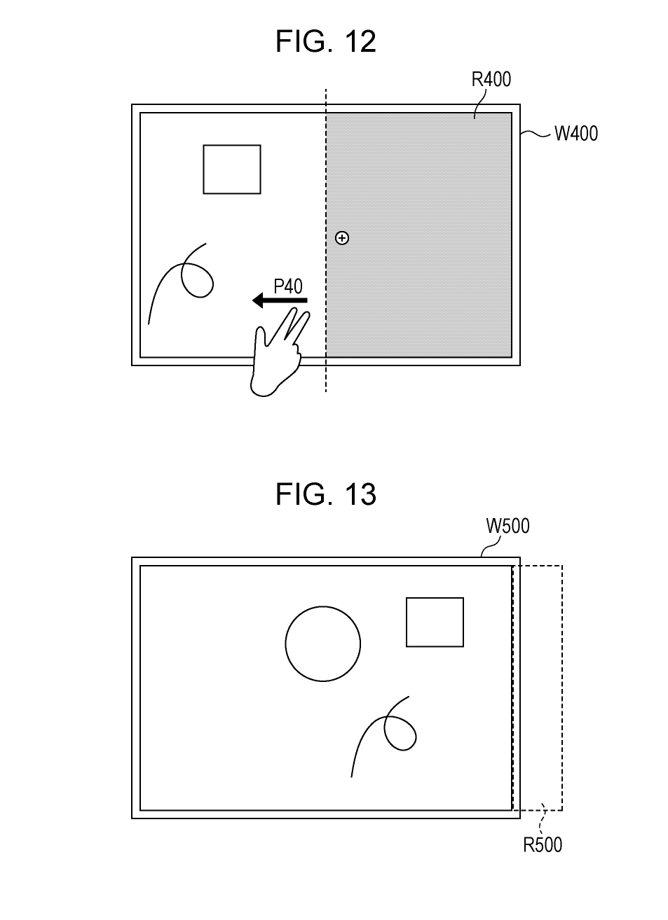

FIG. 12 illustrates an example of a display screen W400. Here, the user performs a drag operation to move a sheet. In FIG. 12, a leftward (direction P40) drag operation is performed, and a sheet moves leftward.

When a sheet end enters the display area and the user keeps performing the drag operation, an outside area R400 is displayed. As the drag operation continues, the outside area R400 becomes larger.

In the present embodiment, the threshold of the outside area is set as a substantially central position of the display area. That is, if a sheet end reaches a substantially central position of the display area, the user can no longer perform a movement operation. That since the upper limit is provided for the drag operation, the user can no longer continue the operation.

According to the present embodiment, a drag operation can be performed within a threshold. As a result, for example, an outside area is not unnecessarily displayed.

### 5. Fifth Embodiment

A fifth embodiment will be described. In the present embodiment, when a sheet is expanded, the displayed sheet is not updated. A functional configuration and processing flows according to the present embodiment are basically the same as those according to the first embodiment, and differences from the first embodiment will be mainly described.

That is, the user makes settings or performs operations such that a displayed sheet is not updated. As a result, in step S1202 in the process for updating a displayed sheet illustrated in FIG. 7, it is determined that a displayed sheet is not to be updated.

FIG. 13 illustrates an example of an operation according to the present embodiment. FIG. 13 illustrates an example of a display screen W500 displayed when a sheet has been expanded according to the present embodiment. For example, in FIG. 8B referred to in the first embodiment, the expansion button M110 is selected and the sheet is expanded. A sheet displayed in the display screen W500 illustrated in FIG. 13, however, is displayed in the same display area as in FIG. 8A.

As a result, a sheet expansion area R500 is created in a virtual area outside the display screen W500. If the user desires to display the sheet expansion area R500, the user needs to further drag the sheet.

### 6. Sixth Embodiment

A sixth embodiment will be described in the present embodiment, a sheet expansion button is not displayed, and a sheet is expanded if an expansion operation is detected. A functional configuration and processing flows according to the present embodiment are basically the same as those according to the first embodiment, and differences from the first embodiment will be mainly described.

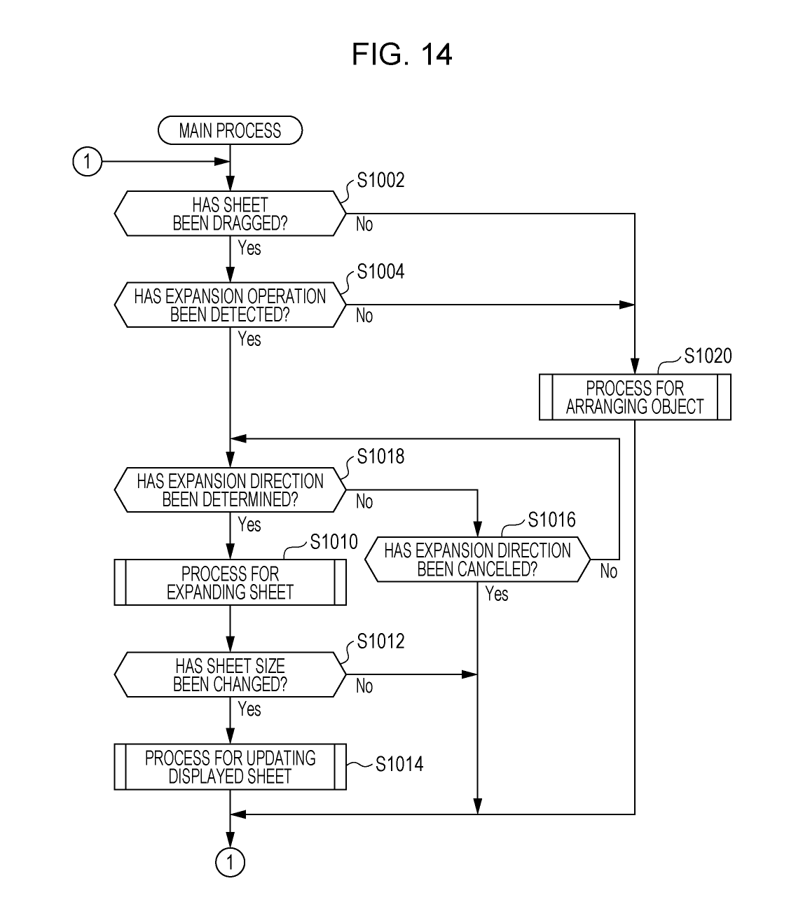

The sixth embodiment is obtained by replacing the main process according to the first embodiment illustrated in FIG. 4 with a main process illustrated in FIG. 14. The same steps are given the same reference numerals, and detailed description thereof is omitted.

In the main process illustrated in FIG. 14, if an expansion operation is detected (YES in step S1004), an expansion direction is determined as a result of the expansion operation.

Various methods may be used to detect an expansion operation, but the following methods may be used.

(1) An outside area is displayed and the outside area remains displayed for a certain period of time or longer (e.g., three seconds or longer)
(2) An outside area is displayed and touched (tapped, double-tapped, etc.)
(3) Unlike a normal drag operation, a drag operation with three fingers is detected
(4) In addition to a normal drag operation (e.g., with the right hand), a touch operation is performed with another finger (e.g., with the left hand)
(5) An outside area is displayed and then a certain gesture pattern input

In these cases, an expansion operation is detected, and a sheet expansion direction is determined on the basis of a direction in which the outside area is displayed.

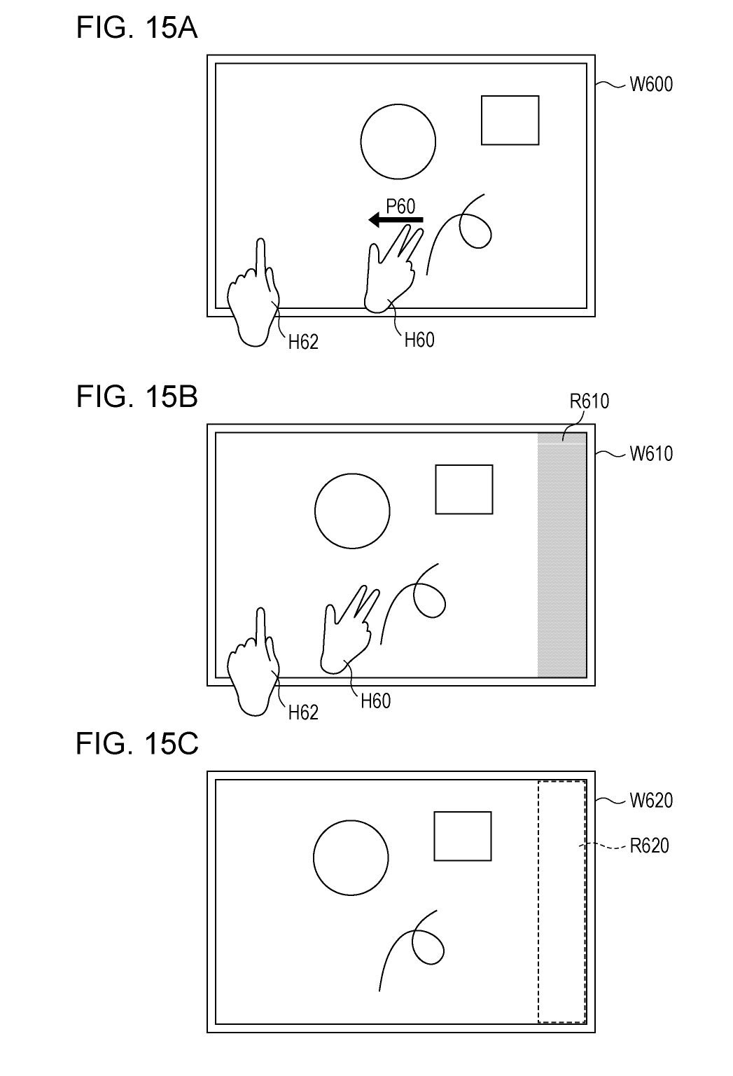

An example of an operation according to the present embodiment will be described with reference to FIGS. 15A to 15C. In a display screen W600 illustrated in FIG. 15A, the user performs a drag operation with two fingers. Here, the user performs a rightward P60 drag operation with two fingers of his/her right hand H60. In addition, the user touches the display screen W600 with his/her left hand H62.

FIG. 15B illustrates an example of a di play screen W610 at a time when the user performs a drag operation with his/her right hand H60 until an outside area R610 is displayed. An outside area R610 is displayed in the display screen W610. Here, no expansion button is displayed in the outside area R610 since the user's left hand H62 is touching the display screen W610.

FIG. 15C illustrates a state achieved by canceling the drag operation and the touch operation in the state illustrated in FIG. 15B. The sheet has been expanded by a sheet expansion area R620, that is, the sheet has been expanded without selecting an expansion button.

According to the present embodiment, the user can easily expand a sheet without displaying an expansion button.

### 7. Seventh Embodiment

A seventh embodiment will be described. In the present embodiment, when a sheet is expanded, the sheet is scaled down so that the entirety of the sheet is included in the display area. A functional configuration and processing flows according to the present embodiment are basically the same as those according to the first embodiment, and differences will be mainly described.

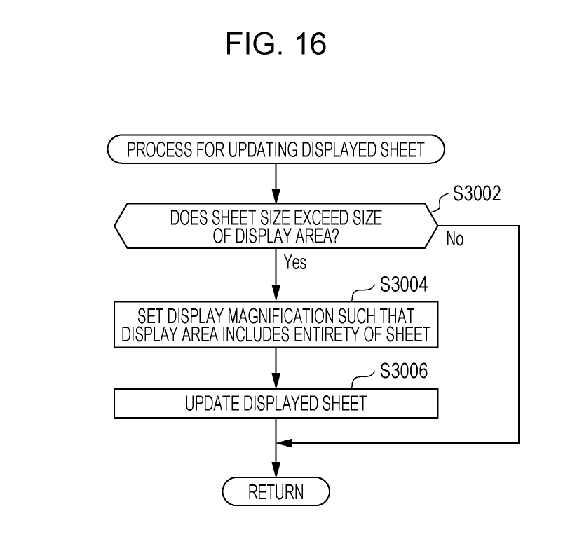

The seventh embodiment is obtained by replacing the process for updating a displayed sheet according to the first embodiment illustrated in FIG. 7 with a process illustrated in FIG. 16.

First, whether the sheet size exceeds the current size of the display area is determined (step S3002). If the sheet size exceeds the current size of the display area (YES in step S3002), display magnification is set such that the display area includes the entirety of the sheet (step S3004). The displayed sheet is then updated on the basis of the set display magnification (step S3006).

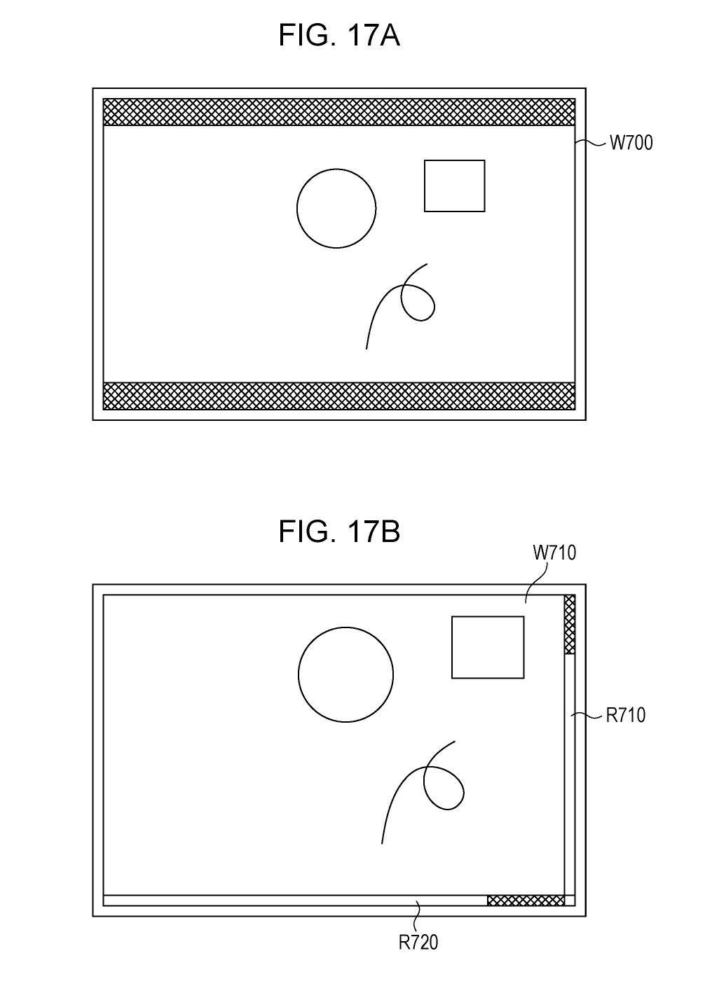

FIG. 17A is a diagram illustrating a display screen W700 in which a sheet has been expanded rightward. Since the sheet size exceeds the display area, the sheet is scaled down and the entirety of the sheet is displayed in the display screen W700.

Here, the sheet is scaled down so that the length or the width of the sheet, whichever exceeds the size of the display area, becomes equal to or smaller than the size of the display area. If the sheet size is increased rightward and then the sheet size is increased upward, for example, the sheet is scaled down so that both the length and the width of the sheet become equal to or smaller than the size of the display area.

In the present embodiment, the scale of a sheet is automatically changed after the sheet is expanded, and the user can view the entirety of the sheet.

Although the entirety of a sheet is displayed by setting the display magnification in step S3004 in the present embodiment, objects may take priority in display and the display magnification may remain the same or the user may change the display magnification, instead. In this case, for example, scroll bars may be displayed in scroll operation areas R710 and R720 as illustrated in FIG. 17B, and a sheet may be moved.

A scroll operation area may be displayed only when the length or the width of a sheet exceeds the size of the display area, or the user may display or remove a scroll operation area.

### 8. Eighth Embodiment

An eighth embodiment will be described. In the present embodiment, a plurality of expansion buttons are selected. A functional configuration and processing flows according to the present embodiment are basically the same as those according to the first embodiment, and differences will be mainly described.

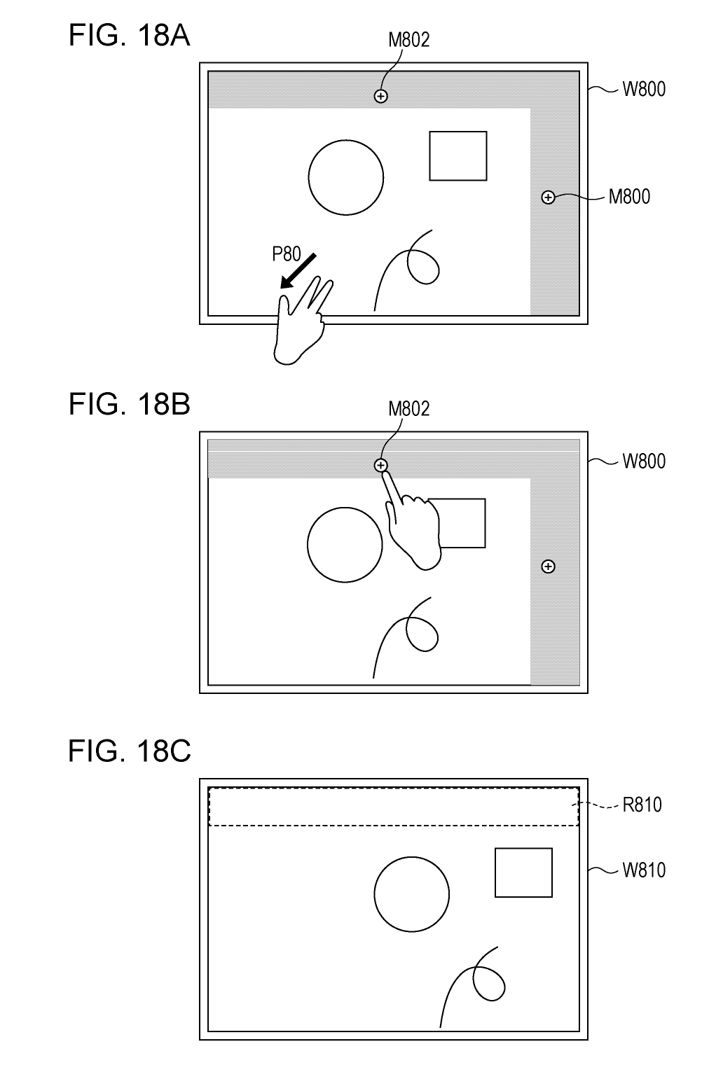

FIGS. 18A and 18B are diagrams illustrating an example of an operation according to the present embodiment. FIG. 18A illustrates an example of a display screen W800 according to the present embodiment. In the display screen W800, the user performs a drag operation in a lower-left direction P80.

As a result of the drag operation, an upper end and a right end of the sheet are displayed. That is, an outside area is displayed above and to the right of the sheet. An expansion button M800 for expanding the sheet rightward and an expansion button M802 for expanding the sheet upward are displayed in the outside area.

If an expansion button is selected, a sheet is expanded in a selected direction. If the expansion button M802 is selected as indicated by the display screen W800 illustrated in FIG. 18B, for example, a sheet expansion area R810 is added to the upper end of the sheet as indicated by a display screen W810 illustrated in FIG. 18C.

Alternatively, a plurality of expansion buttons may be selected. If both the expansion buttons M800 and M802 are selected, for example, expansion directions are determined as upward and rightward. The sheet, therefore, is expanded upward and rightward, and the sheet size increases.

According to the present embodiment, when the user desires to increase the sheet size in a plurality of directions, the user can easily increase the sheet size.

Although an example in which a sheet is expanded. in two directions by selecting two expansion buttons has been described in the present embodiment, a middle point between two expansion buttons may be selected or a new expansion button may be displayed in a diagonal direction, instead.

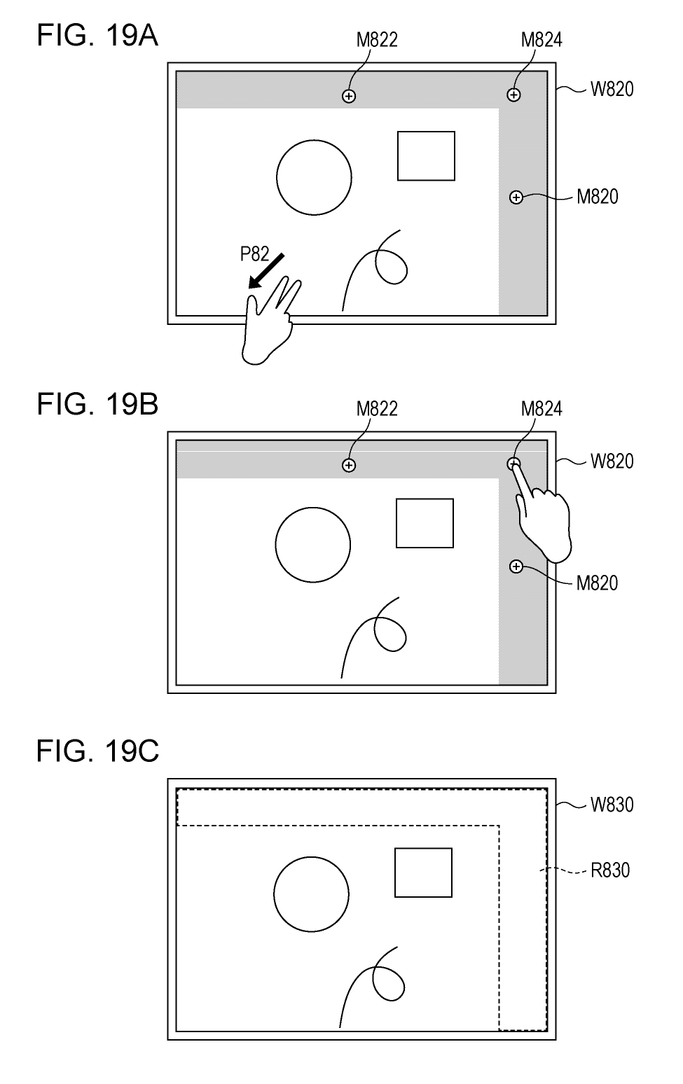

In a display screen W820 illustrated in FIG. 19A, for example, the user performs a drag operation in a lower-left direction P82. As a result, an outside area is displayed above and to the right of the sheet, and the expansion buttons M800 and M802 are displayed. In addition, since the outside area is displayed above and to the right of the sheet, an expansion button M824 is displayed to the upper-right of the sheet.

As indicated by a display screen W820 illustrated in. FIG. 19B, if the expansion button M824 is selected, the sheet size increases by a sheet expansion area R830 as indicated by a display screen W830 illustrated in FIG. 19C. That is, the sheet is expanded upward and rightward, and the sheet size increases.

That is, an expansion direction is determined as a direction relative to the center (around the center) of a display screen, and the sheet is expanded in the expansion direction.

Although a sheet is expanded in two directions in the present embodiment for convenience of description, a sheet may be expanded in three or four (all) directions, instead. In addition, there may be an operation capable of expanding a sheet in a plurality of directions and an operation with which a sheet can be expanded only in one direction.

### 9. Ninth Embodiment

A ninth embodiment will be described. In the present embodiment, a size by which a sheet is to be expanded can be set stepwise by performing a certain operation. A functional configuration and processing flows according to the present embodiment are basically the same as those according to the first embodiment, and differences will be mainly described.

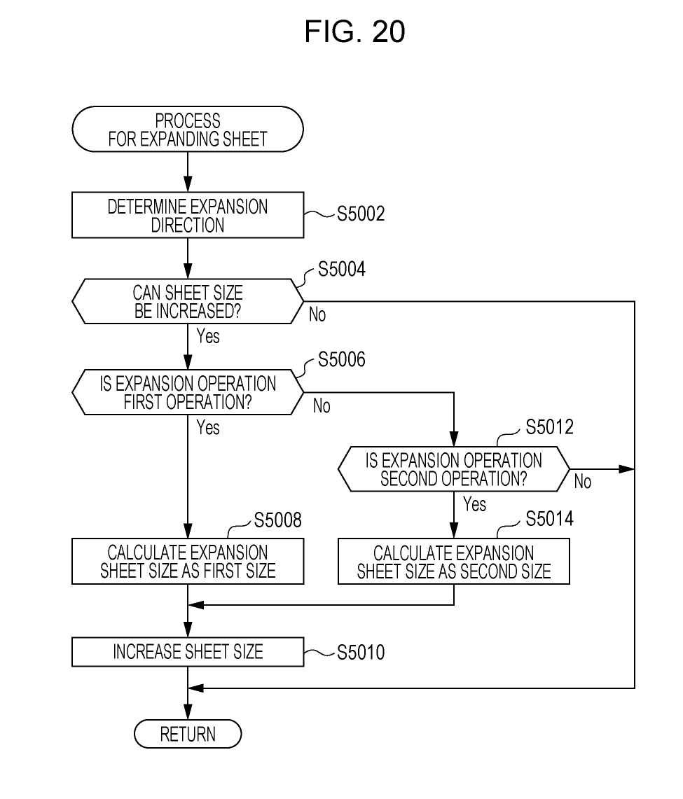

A ninth embodiment is obtained by replacing the process for expanding a sheet according to the first embodiment illustrated in FIG. 5 with a process illustrated in FIG. 20.

First, the user performs an operation for expanding a sheet (e.g., selects an expansion button) to determine an expansion direction (step S5002). If the sheet size can be increased (YES in step S5004), whether the expansion operation is a first operation is determined (step S5006). If the expansion operation is the first operation, an expansion sheet size is calculated as a first size (YES in step S5006→step S5006).

If the expansion operation is a second operation, on the other hand, the expansion sheet size is calculated as a second size (NO in step S5006→YES in step S5012→step S5014). In the present embodiment, other operations do not expand a sheet (NO in step S5006→NO in step S5012).

The sheet is then expanded to the calculated sheet size, namely the first size or the second size (step S5011).

The user can easily perform the first and second. operations in the following exemplary manners:
A tap for the first operation, a double-tap for the second operation
A tap with a finger for the first operation, a tap with two fingers for the second operation
A tap with a hand for the first operation, a touch with a hand and a tap with the other hand for the second operation
Different numbers of taps for the first and second. operations

The first size may be smaller than the second size, or the first size may be larger than the second size. In addition, the first size may be achieved through expansion based on the number of pixels, and the second size may be achieved through expansion based on an expansion. ratio. Alternatively, the second size may be achieved through expansion based on a fixed format. For example, when the second operation has been performed, a sheet may be automatically expanded to A4 size.

### 10. Tenth Embodiment

A tenth embodiment will be described. Although the sheet size is increased in the above embodiments, the sheet size is reduced by performing a certain operation in the present embodiment. A functional configuration and processing flows according to the present embodiment are basically the same as those according to the first embodiment, and differences will be mainly described.

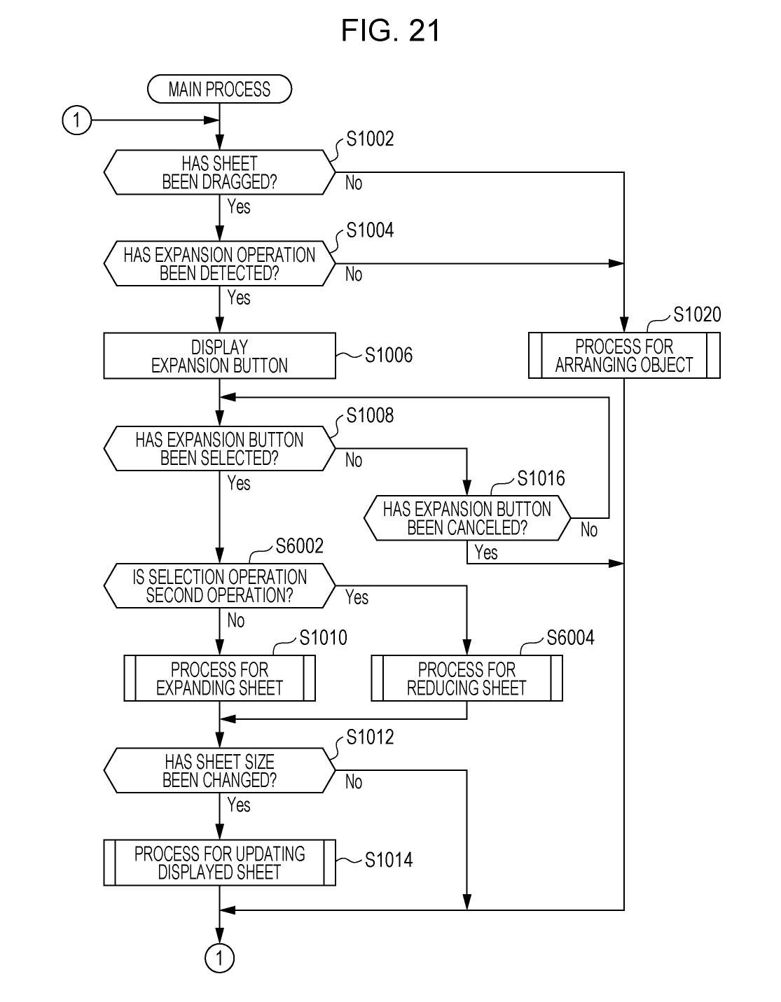

The tenth embodiment is obtained by replacing a part of the main process according to the first embodiment illustrated in FIG. 4 with a process illustrated in FIG. 21.

That is, in addition to the main process according to the first embodiment, if an expansion button is selected (YES in step S1008), whether the selection operation is the second operation is determined (step S6002). If the selection operation is a normal operation, the sheet is expanded as in the first embodiment (NO in step S6002→step S1010). If the second operation is performed, a process for reducing a sheet is performed (YES in step S6002→step S6004).

Here, the sheet is reduced in a direction corresponding to the selected expansion button (a reduction button in this case). As a result, an expanded sheet can be reset to an original size thereof or made smaller than the original size.

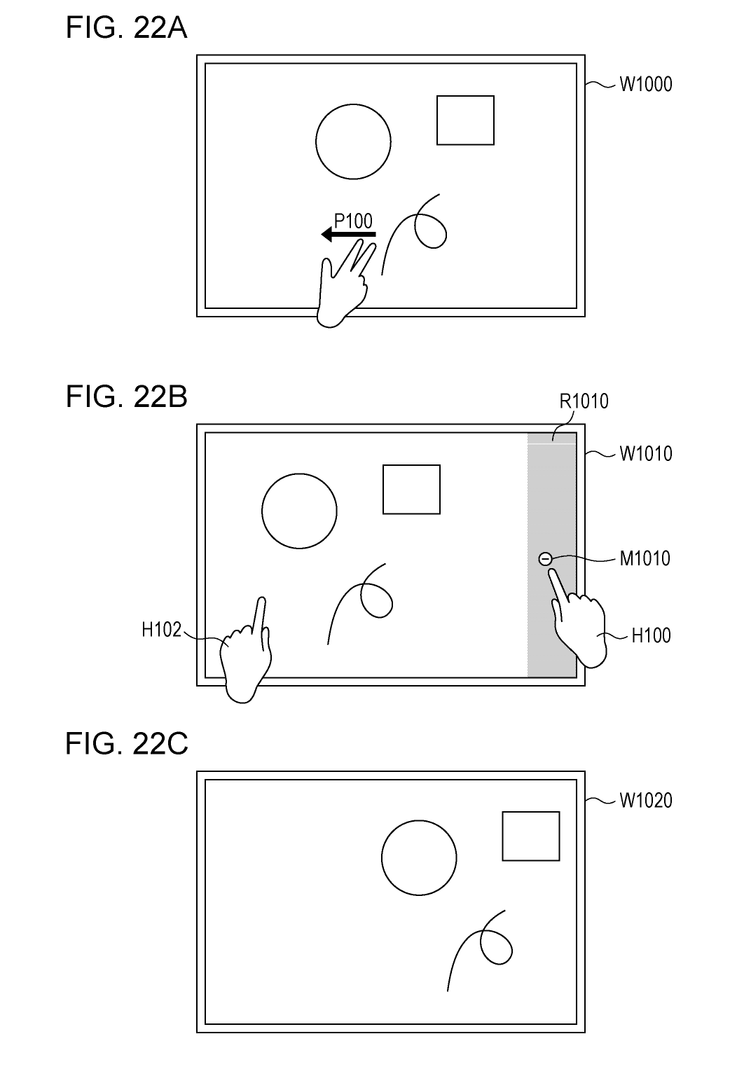

FIG. 22A illustrates an example of a display screen W1000 according to the present embodiment. In the display screen W1000, the user performs a drag operation with two fingers to move a sheet leftward. That is, the drag operation is performed in a direction P100. FIG. 22B illustrates a di-play screen W1010, in which an outside area R1010 is di played as a result of the drag operation.

In the outside area R1010 illustrated in FIG. 22B, a normal expansion button (a “+” button for expanding a sheet in the case of the first embodiment) is displayed. In the present embodiment, the user's left hand H102 touches the sheet as a second operation.

Since the sheet is touched, the second operation is detected. While the sheet is being touched, an expansion button M1010 functions as a reduction button. The expansion button M1010 may include a “−” sign instead of a “+” sign.

Since the expansion button M1010 is touched by the right hand, a certain part of the sheet is removed, and the sheet size is reduced (FIG. 22C). Here, an area opposite to an area to be added to the sheet in the case of expansion is removed to reduce the sheet.

According to the present embodiment, unlike in the above embodiments, a sheet can be reduced.

Alternatively, a direction of an operation may be identified and an operation for expanding a sheet and an operation for reducing a sheet may be distinguished from each other on the basis of a position of a touch and a type of operation (e.g., the number of touches). A. “−” sign may be displayed in the case of the operation for reducing a sheet, and a sheet may be reduced if the “−” sign is selected.

### 11. Eleventh Embodiment

An eleventh embodiment will be described. Whereas there is one display device 10 in the above embodiments, there are a plurality of displays in the present embodiment.

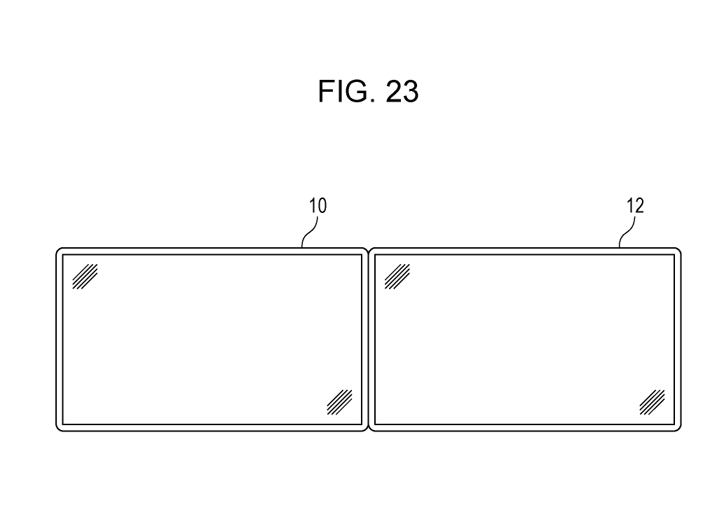

As illustrated in FIG. 23, the display device 10 and a display device 12 are arranged next to each other. That is, when there are a plurality of displays, the display devices 10 and 12 may be considered to together form one display area, or may be considered to form two different display areas.

When a sheet extends over the display devices 10 and 12, the display devices 10 and 12 may be considered to together form one display area. At this time, the expansion menu may be displayed in either of the two di pi devices 10 and 12.

### 12. Modifications

Although the above embodiments of the present disclosure have been described in detail with reference to the drawings, specific configurations are not limited to these embodiments. Designs that do not deviate from the scope of the present disclosure are also included in the aspects of the present disclosure.

Although a touch panel is used as the operation. detection unit and a touch operation (tap operation) is performed in the above embodiments, a click operation may be performed using an external input device such as a mouse, instead.

In addition, in the above embodiments, operations may be stored as history information and an operation. (undo) in which a previous operation is canceled using the history information may be performed. As a result, even if a sheet is expanded by mistake, the sheet can be easily reset to an original size thereof.

In a cancel operation, only a previous operation may be canceled, or a plurality of operations may be canceled. In addition, a cancel operation may be performed in combination with drawing or arrangement of an object.

A program operating on the device in each embodiment is a program (a program for causing a computer to function) for controlling a CPU or the like in such a way as to achieve the functions according to the embodiment. When processed, information handled in the device is temporarily accumulated in a temporary storage device (e.g., a random-access memory (RAM)), and then stored in a storage device such as a read-only memory (ROM), an HDD, or an SSD. The CPU reads, modifies, or rewrites the information as necessary.

When such a program is put on the market, the program may be stored in a portable recording medium, or may be transferred to a server computer through a network such as the Internet. In this case, it is needless to say that the present disclosure includes a storage device included in the server computer.

The present disclosure contains subject matter related to that disclosed in Japanese Priority Patent Application. JP 2016-246990 filed in the Japan Patent Office on Dec. 20, 2016, the entire contents of which are hereby incorporated by reference.

1 should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a sheet display unit that displays a sheet on which an object is to be arranged;
a movement operation reception snit that receives as operation for moving the sheet;
an expansion button display unit that, if an outside area is displayed as a result of the operation for moving the sheet, displays an expansion button; and
a sheet expansion unit that, if the expansion button is selected, increases sheet size of the sheet in a direction of the selected expansion button.

2. The display device according to claim 1,
wherein the sheet display unit displays a part or entirety of the sheet as a display area and, if the sheet expansion unit has increased the sheet size, displays the sheet while updating the display area such that the display area includes an expansion of the sheet.

3. The display device according to claim 1,
wherein, if the sheet expansion unit has increased the sheet size, the sheet display unit sets a display magnification such that the display area includes entirety of the sheet, and displays the sheet with the display magnification.

4. The display device according to claim 1,
further including a storage unit that stores an expansion size,
wherein the sheet expansion unit increases the sheet size by the stored expansion size in the direction of the selected expansion button.

5. The display device according to claim 1,
wherein the sheet expansion unit increases the sheet size by a size of the outside area in the direction of the selected expansion button.

6. A display method used in a display device, the display method comprising:
displaying a sheet on which an object is to be arranged;
receiving an operation for moving the sheet;
displaying, if an outside area is displayed as a result of the operation for moving the sheet, an expansion button; and
increasing, if the expansion button is selected, sheet size of the sheet in a direction of the selected expansion button.

7. A non-transitory computer readable medium storing a program for causing a computer to perform operations comprising:
displaying a sheet on which an object is to be arranged;
receiving an operation for moving the sheet;
displaying, if an outside area is displayed as a result of the operation for moving the sheet, an expansion button; and
increasing, if the expansion button is selected, sheet size of the sheet in a direction of the selected expansion button.
